(19) United States
(12) Patent Application Publication
(10) Pub. No.: US 2019/0005401 A1
(43) Pub. Date: Jan. 3, 2019

(54) A METHOD AND A SYSTEM FOR DETERMINING A CONCENTRATION RANGE FOR A SAMPLE BY MEANS OF A CALIBRATION CURVE

(71) Applicant: GE Healthcare Bio-Sciences AB, Uppsala (SE)

(72) Inventors: Asa FROSTELL-KARLSSON, Uppsala (SE); Niklas RYDEN, Uppsala (SE); Johan Hans Fredrik KARNHALL, Uppsala (SE)

(21) Appl. No.: 15/741,372

(22) PCT Filed: Jun. 30, 2016
(86) PCT No.: PCT/EP2016/065388

§ 371 Date: Jan. 2, 2018

(30) Foreign Application Priority Data
Jul. 2, 2015 (GB) 1511587.6

(51) Int. Cl. G06N 7/00; G01N 15/06; G01N 21/27; G01N 21/552

(52) U.S. Cl. CPC G06N 7/00; G01N 15/06; G01N 21/274; G01N 2201/129; G01N 2015/0693; G01N 2201/12746; G01N 21/553

(57) ABSTRACT

A system and a method for determining a concentration region for a measurement of a response value by means of a calibration curve is disclosed. The calibration curve includes response values as a function of concentrations. The method includes providing a series of measured calibration data; fitting a regression model to the series of measured calibration data; calculating a standard deviation and a standard error for the measured calibration data; calculating a probability using the t-distribution with parameters including degrees of freedom and a requested confidence interval; calculating a response value interval; applying the response value interval to the calibration model; measuring a response value for a sample; and determining the concentration region by means of the response value interval and the calibration model.

### TECHNICAL FIELD

The present invention relates to a method and a system for determining a concentration range for a sample using a calibration curve.

### BACKGROUND

The analysis of concentration of an analyte sample is a common analysis performed by means of label-free interaction analysis (LFIA). The concentration analysis may use a calibration curve with response values for different concentrations of the analyte. By determining the relationship between the magnitude of a peak (response value) for a known amount of analyte in a standard for several samples, the relationship (the calibration curve) may be used to estimate the amount of that specific analyte in a sample of unknown concentration. However, the uncertainty of the measured concentration is of great interest, and especially the range of possible concentrations corresponding to the measured response value. A method for performing such assessments in concentration analysis is disclosed in a manual from GE Healthcare, “Biacore concentration analysis handbook”, BR-1005-12 Edition AB.

It is an object of the present invention to provide a method for determining the range of possible concentrations corresponding to a measured response value.

Another object of the present invention is to provide a method for determining a concentration interval with a maximum predetermined error.

### SUMMARY

The above object, and further possible objects that can be construed from the disclosure below, are met by a first aspect of the invention constituted by a method for determining a concentration region for a measurement of a response value by means of a calibration curve. The calibration curve comprises a response value as a function of a concentration, wherein the method comprises providing a series of measured calibration data, fit a regression model to the provided series of measured calibration data, determining a standard deviation for the measured calibration data, and calculating a standard error for the measured calibration data. The method further comprises calculating a probability using the t-distribution with parameters from a group comprising: degrees of freedom, and the requested confidence interval. The method further comprises calculating a response value interval as a product of the standard error and the probability, applying the response value interval to the calibration model, measuring a response value for a sample, and determining a region with a predefined precision by means of the response value interval and the calibration model.

This has the effect that for a given response value the resulting concentration range may easily be calculated.

Other objects, advantages and features of embodiments of the invention will be explained in the following detailed description in conjunction with the accompanying drawings.

### BRIEF DESCRIPTION OF THE DRAWINGS

FIG. 1 is a flow diagram illustrating a method according to a first embodiment of the invention;

FIG. 2 is a plot of a calibration curve, a fitted response, and a measurement of a response value;

FIG. 3 is a plot of a calibration curve, a fitted response, and concentration regions;

FIG. 4 is a plot of a calibration curve, a fitted response, and concentration regions; and

FIG. 5 is a schematic diagram illustrating a system.

### DETAILED DESCRIPTION

The present inventors have devised a way to assess the possible concentration range for a measurement of a response value, using a calibration curve that shows the relationship between a response value from a measurement and a concentration of an analyte. This method is especially useful in concentration analysis in label free interaction analysis (LFIA).

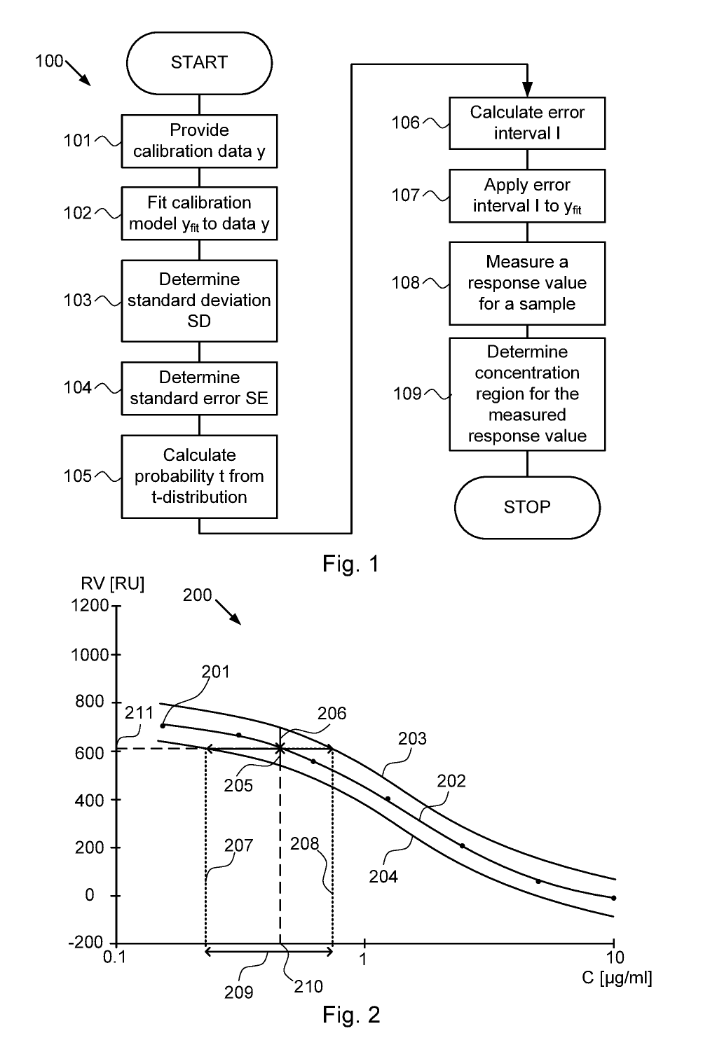

In a first embodiment of the present invention, a method is disclosed with reference made to a flowchart shown in FIG. 1, generally designated 100. The method comprises steps of:

101: Providing calibration data (y) comprising a response value as a function of a parameter. The parameter may be a concentration of an analyte.
102: Fit a model to the calibration data. This model may be a regression model. The fitted model provides a calculated response yfit.
103: Determine the standard deviation (SD) of the calibration data.
104: Determine the standard error (SE) of the calibration data:

SE=SD/(√n)
Where n is the number of observations and SD is the standard deviation.
   105: Calculate a probability (t) by means of the two tailed t-distribution, with the parameters f (degree of freedom) and CI (requested confidence interval).
   106: Calculate an error interval by means of multiplying the standard error (SE) with the probability (t):

I=SE×t(f,CI)

107: Apply the calculated error interval (I) to the fitted response (yfit).
108: Measure a response value for a sample. A response value can for example be measured by means of a label free interaction analysis (LFIA) such as a surface plasmon resonance (SPR) measurement.
109: Determine the concentration region for the measured response value, by means of the calculated error interval (I) and the fitted response (yfit).

The step 107 of applying the calculated error interval (I) to the fitted response (yfit) may involve adding the calculated error interval (I) to the fitted response (yfit), thereby obtaining an upper curve. Accordingly, a corresponding lower curve may be obtained by subtracting the calculated error interval (I) from the fitted response (yfit).

The step 109 of determining the concentration region for a measured sample may then be performed by calculating the higher concentration in the concentration region as the concentration corresponding to the measured response value of the upper curve. Accordingly, the lower concentration in the concentration region may be obtained as the concentration corresponding to the measured response value of the lower curve.

The first embodiment is further described with reference made to FIG. 2. In FIG. 2 a plot 200 of a response value (RV) against concentration (C) is shown. In the plot, calibration data points 201 are shown together with a corresponding fitted model (yfit) 202, which in one embodiment may be a regression model. Furthermore, an upper curve 203 and a lower curve 204 are calculated as disclosed above. A measurement of a response value 211 is also shown in the figure. Due to uncertainties in the measurement of the response value and the calibration curve, a measurement of a response value is likely to represent a concentration in a range, rather than an exact concentration as calculated with the fitted model (yfit). In order to calculate the concentration range 209 corresponding to said measurement of the response value 211, the concentration from the lower curve 204 at the response value 211 is defined as the lower concentration 207 in the concentration range 209. A higher concentration 208 in the concentration range 209 is defined as the concentration corresponding to the response value 211 given by the upper curve 203. The concentration region 209 is defined as the region between the lower concentration 207 and the higher concentration 208. The estimated concentration from the model can be found on the concentration axis (x-axis) at a point 210.

The plot 200 in FIG. 2 also suggests that by obtaining a response value in a region of the calibration curve with rapid change in response value, a smaller concentration region is possible to obtain. This means that a more reliable measurement of the concentration is attainable by measuring a response value in a region of the calibration curve with rapid change in response value. The plot also shows that large concentration ranges are possible if response values corresponding to end sections of the calibration curve are measured, which may be un-advantageous in precise measurements.

In FIG. 2 a constant calculated error interval (I) 205, 206 is used for calculating the lower curve 204 and the upper curve 204, respectively. This calculated error interval may correspond to the largest calculated error interval for the calibration data. However, a varying calculated error interval may also be used, wherein the calculated error interval is calculated for each calibration data point 201. This may be especially useful since the calculated error interval usually is smaller at higher concentrations.

Other methods for obtaining the calculated error interval (I) are of course possible, such as for example calculating the standard variance i.e. dividing the standard deviation with the mean value.

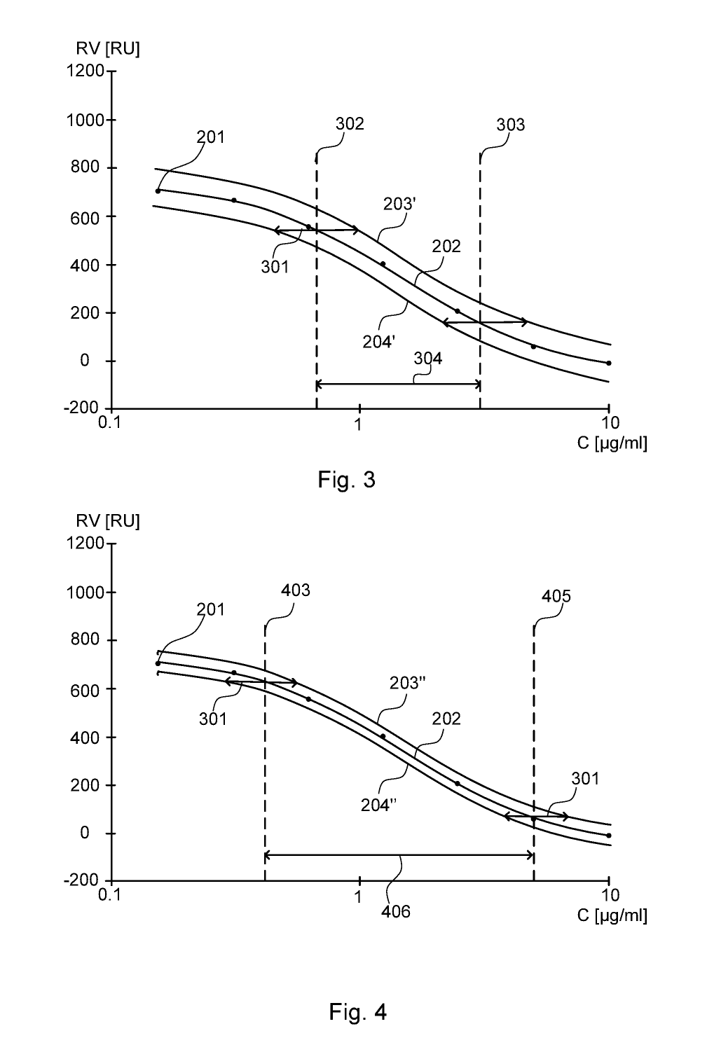

In FIG. 3 a third embodiment of the invention is disclosed. A predetermined maximum concentration region may be defined as the maximum allowed horizontal distance between the upper curve 203′ and the lower curve 204′. From the plot it is noted that the concentration region becomes smaller when the concentration increases due to the increased slope of the fitted model, for even larger concentrations the slope of the fitted model decreases causing the corresponding concentration region to gradually increase.

A first concentration 302 is defined as the lower concentration having a concentration region 301 equal to the predetermined concentration region. A second concentration 303 is defined as the higher concentration having concentration region 301 equal to the predetermined concentration region. The second concentration 303 is larger than the first concentration 302.

The first concentration 303 and the second concentration 305 define a concentration interval 304 with a maximum error for a measured response value. This concentration interval 304 may be used for determining a concentration with a maximum allowed error.

In FIG. 4 another embodiment is disclosed that shows that by decreasing the constant interval (I), the upper curve 203″ and the lower curve 204″ are closer to each other, which means that the first concentration 403 and the second concentration 405 move away from each other causing the concentration interval 406 with the maximum error to be longer.

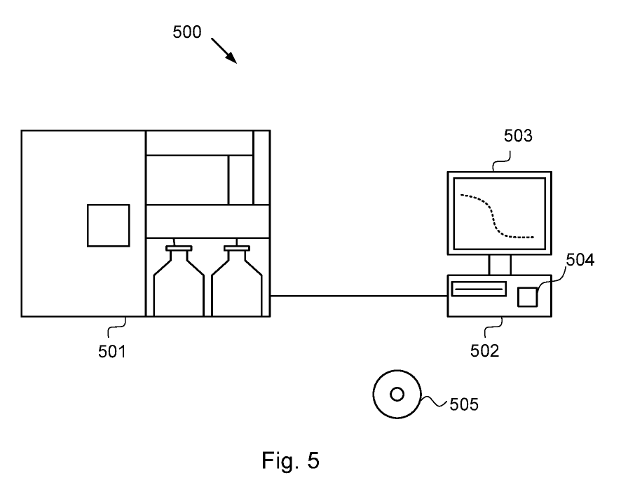

In FIG. 5 a second embodiment of the invention is disclosed. This second embodiment of the invention involves a label-free interaction analysis (LFIA) system, generally designated 500. The LFIA system 500 comprises an analysis device 501 and a computer 502 with a connected computer screen 503. The computer 502 comprises a memory 504 containing instructions such that the above described method is executed when a processor of the computer 502 executes its control program.

In another embodiment, a computer readable media 505 is programmed to contain instructions such that when executed by a processor the above disclosed method is performed.

The embodiments of the invention described with reference made to FIG. 3-5 may be especially useful for determining a suitable concentration range for a process, and for providing visual guidance by means of a graphical user interface.

In one embodiment may the analysis device 501 be a surface plasmon resonance (SPR) device.

In one embodiment, the computer 502 and/or the computer screen 503 may be integrated in the housing of the analysis device 501. Whereby, an integrated solution is formed.

In one embodiment, the method described hereinabove is executed by a firmware in the analysis device 501.

In another embodiment, the instructions for executing the method according to embodiments of the invention is performed by cloud computing.

In yet another embodiment of the present invention is the computer readable media a network connection to server.

1. A method for determining a concentration region for a measurement of a response value by means of a calibration curve, the calibration curve comprises response values as a function of concentrations, wherein the method comprising:
providing a series of measured calibration data;
fitting a regression model to the provided series of measured calibration data;
calculating a standard deviation for the measured calibration data;
calculating a standard error for the measured calibration data;
calculating a probability using the t-distribution with parameters, the parameters comprising degrees of freedom, and a requested confidence interval;
calculating a response value interval as a product of the standard error and the probability;
applying the response value interval to the calibration model;
measuring a response value for a sample;
determining the concentration region by means of the response value interval and the calibration model.

2. The method of claim 1, wherein the step of applying the response value interval comprises:
calculating a lower curve by means of subtracting the response value interval from the calibration model;
calculating an upper curve by means of adding the response value interval to the calibration model;
calculating the concentration region using the lower curve, the upper curve and a given response value.

3. The method of claim 1, wherein the method further comprises:
calculating a first concentration corresponding to a predetermined maximum concentration region;
calculating a second concentration corresponding to a predetermined maximum concentration region, wherein the second concentration region is larger than the first concentration region;
defining a concentration interval from the first concentration to the second concentration.

4. A computer readable media containing instructions for carrying out the method of claim 1, when executed by a processor.

5. A label free interaction analysis system, comprising:
an analysis device;
a control unit comprising a processor and a memory, wherein the memory contains instructions for carrying out the method of claim 1, when executed by the processor.

6. A-The label free interaction analysis system of claim 5, wherein the analysis device is a surface plasmon resonance device.
